(19) United States
(12) Patent Application Publication
(10) Pub. No.: US 2009/0293024 A1
(43) Pub. Date: Nov. 26, 2009

(54) Detecting Circuit Design Limitations and Stresses Via Enhanced Waveform and Schematic Display

(76) Inventors: Richard Scott Brink, Rochester, MN (US); Delbert R. Cecchi, Rochester, MN (US); Michael Robert Curry, Rochester, MN (US); Raymond Alan Richetta, Rochester, MN (US); Timothy Joseph Schmerbeck, Mantorville, MN (US)

Correspondence Address: IBM CORPORATION;ROCHESTER IP LAW DEPT 917, 3605 HIGHWAY 52 N, ROCHESTER, MN, 55901-7829, US

(21) Appl. No.: 12/126,157

(22) Filed: May 23, 2008

(51) Int. Cl. G06F 17/50

(52) U.S. Cl. 716/4

(57) ABSTRACT

A method and apparatus are provided for implementing enhanced detection of circuit design limitations and stresses via enhanced waveform and schematic display. A selected simulation is run, for example, a transient, an AC, or a DC simulation. Then a displayed schematic highlights problem areas using a color set selected by a circuit designer.

### FIELD OF THE INVENTION

The present invention relates generally to the data processing field, and more particularly, relates to a method and apparatus for implementing enhanced detection of circuit design limitations and stresses via enhanced waveform viewing capability.

### DESCRIPTION OF THE RELATED ART

Circuit performance specifications can be limited by active devices changing their operating regions as process, temperature and supply voltage (PTV) variations occur.

For example, metal oxide semiconductor (MOS) devices changing from sub-threshold, to linear, to saturation, or bipolar devices from linear to saturation, may cause circuit performance to degrade significantly as device output impedance changes with the device's region of operation. Also, each technology has voltage limits across device terminals to ensure long term design reliability.

Both of these types of scenarios are currently difficult to detect, as a circuit designer would need to query each device individually for any of these boundary conditions.

As a simple example, to ensure a MOS device's technology based voltage limits are not exceeded, a circuit designer would need to set a waveform viewer to measure the appropriate voltages across the device terminals and then examine each resulting wave during a transient simulation.

The next step would be to query each of the device's technology voltage limitations and then next examine all terminal voltages specifications across all of the devices in the design to prevent all possible stress condition occurrences. Obviously as designs get larger and larger this task becomes enormous and unwieldy.

A need exists for an effective mechanism for implementing enhanced detection of circuit design limitations and stresses.

### SUMMARY OF THE INVENTION

A principal aspect of the present invention is to provide a method and apparatus for implementing enhanced detection of circuit design limitations and stresses. Other important aspects of the present invention are to provide such method and apparatus for implementing enhanced detection of circuit design limitations and stresses substantially without negative effect and that overcome many of the disadvantages of prior art arrangements.

In brief, a method and apparatus are provided for implementing enhanced detection of circuit design limitations and stresses via enhanced waveform and schematic display. A schematic of a circuit is entered. Device parameters are entered and thresholds for each device parameter are set. A selected simulation for the circuit is run. The schematic is displayed with highlighted problem areas responsive to the simulation.

In accordance with features of the invention, a user selected color set is provided. The user selected color set includes respective selected colors for each device parameter having a value exceeding a set threshold. The displayed schematic highlights problem areas using the color set selected by a circuit designer. The selected simulation includes, for example, a transient, an AC, and a DC simulation.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 is a block diagram representations illustrating an exemplary computer test system for implementing enhanced detection of circuit design limitations and stresses in accordance with the preferred embodiment;

FIG. 2 is a flow chart illustrating exemplary steps for implementing enhanced detection of circuit design limitations and stresses in accordance with the preferred embodiment;

FIG. 3 is a block diagram illustrating a computer program product in accordance with the preferred embodiment.

### DETAILED DESCRIPTION OF THE PREFERRED EMBODIMENTS

In accordance with features of the invention, a method is provided for improved detection of both technology imposed voltage limits and the changing of a device's operating region by using the schematic to highlight problem areas with selected colors defined by the circuit designer.

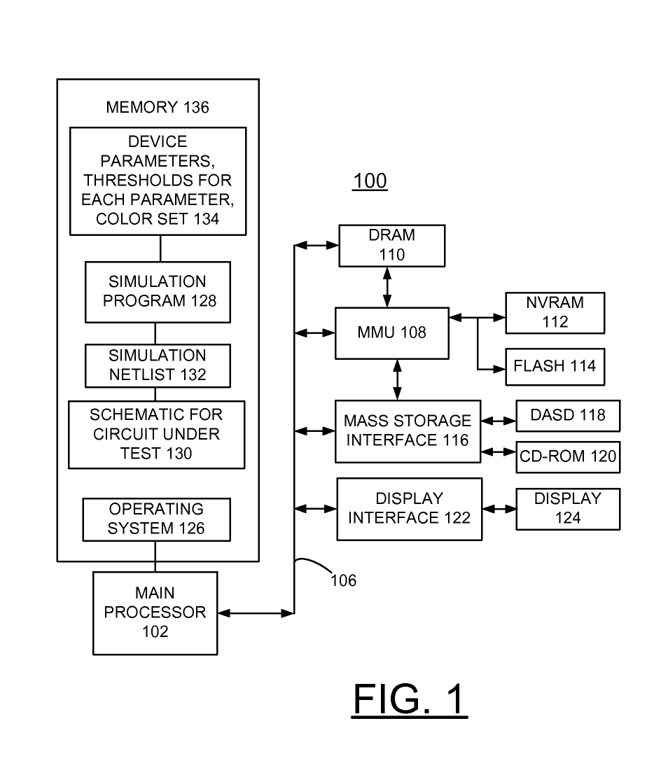

Referring now to the drawings, in FIG. 1 there is shown an exemplary computer test system generally designated by the reference character 100 for implementing enhanced detection of circuit design limitations and stresses in accordance with the preferred embodiment.

Computer system 100 includes a main processor 102 or central processor unit (CPU) 102 coupled by a system bus 106 to a memory management unit (MMU) 108 and system memory including a dynamic random access memory (DRAM) 110, a nonvolatile random access memory (NVRAM) 112, and a flash memory 114. A mass storage interface 116 coupled to the system bus 106 and MMU 108 connects a direct access storage device (DASD) 118 and a CD-ROM drive 120 to the main processor 102.

Computer system 100 includes a display interface 122 connected to a display 124, and a test interface 126 coupled to the system bus 106. Testing in accordance with the preferred embodiment advantageously is preformed using a selected simulation with circuit design parameters measured during a transient, an AC, or a DC simulation.

Computer system 100 includes an operating system 126, a simulation program 128 of the preferred embodiment, a schematic for a circuit under test 130, a simulation netlist 132, and a set of device parameters, thresholds for each parameter, and a color set 134 of the preferred embodiment resident in a memory 136.

As used in the present specification and claims, the terms a set of device parameters, thresholds for each parameter, and a color set 134 should be broadly understood as follows. Device parameters include minimum and maximum operating regions for devices including linear and saturated regions of operation in bipolar devices; linear, saturated, and sub-threshold regions of operation in field effect transistors (FETs), current maximums in FETs, resistors, and wires; technology imposed voltage limits across device terminals, and current limits. Thresholds for each parameter include both minimum and maximum values for each parameter. Color set includes colors and highlighting including bold, wider, and dotted lines.

Computer test system 100 is shown in simplified form sufficient for understanding the present invention. The illustrated computer test system 100 is not intended to imply architectural or functional limitations. The present invention can be used with various hardware implementations and systems and various other internal hardware devices, for example, multiple main processors.

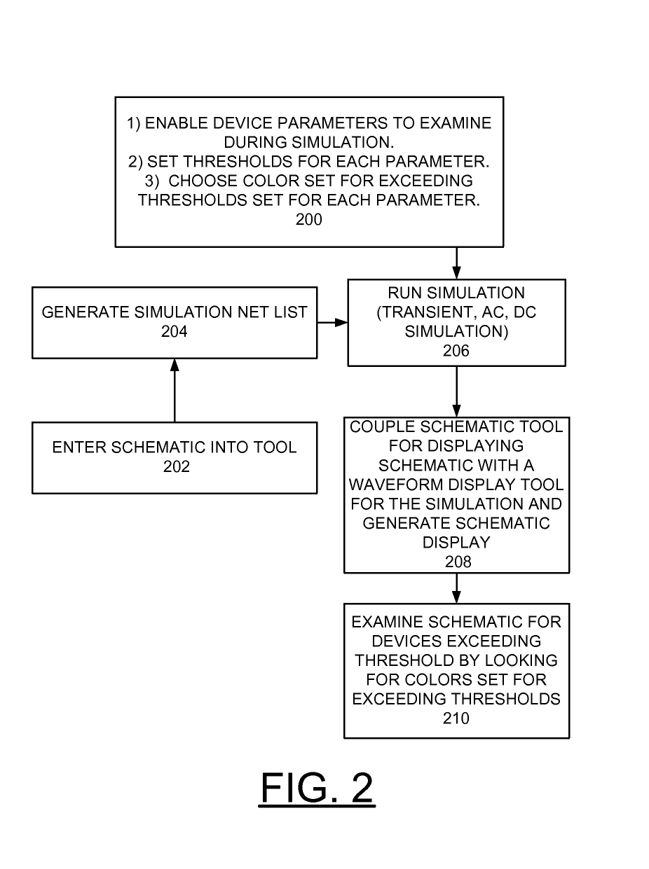

Referring now to FIG. 2, there are shown exemplary steps for implementing enhanced detection of circuit design limitations and stresses in accordance with the preferred embodiment starting at a block 200 where 1) device parameters 134 to examine during simulation are enabled; 2) thresholds 134 for each parameter are set; and 3) a color set 134 for exceeding the set thresholds for each parameter is selected by a user. A schematic for a circuit under test 130 is entered into as indicated at a block 202. A simulation netlist 132 is generated for the schematic for a circuit under test 130 as indicated at a block 204.

A selected simulation is run as indicated at a block 206, for example, an AC, or a DC simulation. Then a displayed schematic at a block 208 highlights problem areas using the color set 134 selected by the user or circuit designer.

After a simulation has completed the simulation program 128 uses the waveform display tool coupled to the schematic entry tool to generate and display a schematic for the simulation as indicated at a block 208. A generated schematic display enables the display of the schematic with the user defined color set for parameters exceeding thresholds set for each device parameter. Thus the circuit designer is enabled to easily and effectively examine circuit performance as indicated at a block 210 by examining schematic for devices exceeding thresholds by looking for colors set for exceeding thresholds.

The displayed schematic at bock 210 includes features of displayed waveforms that may include but are not limited to, for example, the examination of transient waves representing node voltages and device currents, AC response of a circuit represented in bode plots, and other important circuit parameters. Circuit design parameters are measured during a transient, an AC, or a DC simulation at block 206. The displayed schematic at bock 210 includes predefined selected colors for highlighting devices exceeding a technology voltage limit and a set current limit. The displayed schematic at bock 210 includes predefined selected colors for highlighting devices where the device is linear and a device is operating in the saturation region.

In accordance with features of the invention, the schematic entry tool is closely coupled to a waveform display tool for the simulation. This advantageously is accomplished several ways in the displayed schematic at block 210 after running the simulation at block 206. For example, during the examination of a transient waveform as the cursor is moved across the waveforms the simulation program 128 keeps track of time in the simulation. As the cursor is moved across the transient waveforms, devices in the displayed schematic change color based upon the parameters and colors set by the designer. Programmable parameters are provided to set and prioritize colors that flash up in the schematic. For example a device may be one color when a technology voltage limit is exceeded and another color if the device is linear and another color if a device is in the saturation region. Another example is that a device could change colors if a current limit is exceeded.

One simplified example of this invention includes driver performance in an HSS core which is degraded at low power supply levels when the NMOS tail current source transitions from the saturation or high output impedance, to the linear or lower output impedance regions. When this tail current source becomes linear several degradations occur:

1.) Tail current reduces which in turn reduces output signal swing
2.) Tail current reduction also degrades output fall times which closes the output eye.
3.) Common mode noise worsens.
Therefore, it can be seen from a displayed schematic at block 208 after running the simulation at block 206 that the tail current device at the driver needs to be saturated so as to limit the degradation of several important circuit specifications.

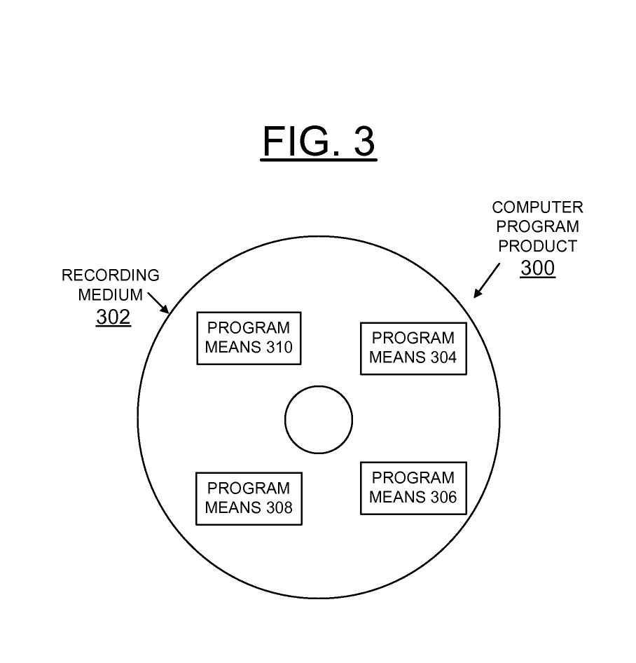

Referring now to FIG. 3, an article of manufacture or a computer program product 300 of the invention is illustrated. The computer program product 300 includes a recording medium 302, such as, a floppy disk, a high capacity read only memory in the form of an optically read compact disk or CD-ROM, a tape, or another similar computer program product. Recording medium 302 stores program means or instructions 304, 306, 308, 310 on the medium 302 for carrying out the methods for implementing enhanced detection of circuit design limitations and stresses of the preferred embodiment in the system 100 of FIG. 1.

A sequence of program instructions or a logical assembly of one or more interrelated modules defined by the recorded program means 304, 306, 308, 310, direct the computer system 100 for implementing enhanced detection of circuit design limitations and stresses of the preferred embodiment.

While the present invention has been described with reference to the details of the embodiments of the invention shown in the drawing, these details are not intended to limit the scope of the invention as claimed in the appended claims.

What is claimed is:

1. A method for implementing enhanced detection of circuit design limitations and stresses comprising:
entering a schematic of a circuit;
entering device parameters and setting thresholds for each device parameter;
running a selected simulation for the circuit; and
displaying the schematic with highlighted problem areas responsive to the simulation.

2. The method for implementing enhanced detection of circuit design limitations and stresses as recited in claim 1 further includes receiving a user selected color set for predefined operations below and above the thresholds set for each device parameter.

3. The method for implementing enhanced detection of circuit design limitations and stresses as recited in claim 2 wherein displaying the schematic with highlighted problem areas includes displaying the schematic using said user selected color set for predefined operations below and above the thresholds set for each device parameter for the highlighted problem areas.

4. The method for implementing enhanced detection of circuit design limitations and stresses as recited in claim 1 includes generating a simulation net list for the entered schematic.

5. The method for implementing enhanced detection of circuit design limitations and stresses as recited in claim 1 wherein running a selected simulation for the circuit includes running a transient simulation.

6. The method for implementing enhanced detection of circuit design limitations and stresses as recited in claim 1 wherein running a selected simulation for the circuit includes running an AC simulation.

7. The method for implementing enhanced detection of circuit design limitations and stresses as recited in claim 1 wherein running a selected simulation for the circuit includes running a DC simulation.

8. The method for implementing enhanced detection of circuit design limitations and stresses as recited in claim 1 wherein displaying the schematic with highlighted problem areas responsive to the simulation includes coupling a schematic display tool for displaying the schematic with a waveform display tool for the simulation.

9. The method for implementing enhanced detection of circuit design limitations and stresses as recited in claim 1 wherein displaying the schematic with highlighted problem areas includes displaying the schematic using a user selected color set, said user selected color set including respective selected colors for each device parameter having a value operating outside a set threshold.

10. The method for implementing enhanced detection of circuit design limitations and stresses as recited in claim 9 wherein displaying the schematic with highlighted problem areas includes displaying the schematic with user selected colors for devices operating outside a technology imposed voltage limit.

11. The method for implementing enhanced detection of circuit design limitations and stresses as recited in claim 9 wherein displaying the schematic with highlighted problem areas includes displaying the schematic with user selected colors for devices operating outside a set current limit.

12. The method for implementing enhanced detection of circuit design limitations and stresses as recited in claim 9 wherein displaying the schematic with highlighted problem areas includes displaying the schematic with user selected colors for bipolar devices operating in a saturation region.

13. An apparatus for implementing enhanced detection of circuit design limitations and stresses comprising:
a simulation program embodied in a machine readable storage medium receiving a schematic of a circuit;
said simulation program receiving user entered device parameters and set thresholds for each device parameter;
said simulation program running a selected simulation for the circuit; and
said simulation program displaying the schematic with highlighted problem areas responsive to the simulation.

14. The apparatus for implementing enhanced detection of circuit design limitations and stresses as recited in claim 13 wherein said simulation program includes a waveform display tool coupled to a schematic tool; said schematic tool displaying the schematic with highlighted problem areas responsive to the simulation.

15. The apparatus for implementing enhanced detection of circuit design limitations and stresses as recited in claim 13 wherein said simulation program receives a user selected color set, said user selected color set including respective selected colors for each device parameter having a value operating outside a set threshold.

16. The apparatus for implementing enhanced detection of circuit design limitations and stresses as recited in claim 15 wherein said simulation program displays the schematic with user selected colors for devices operating outside a technology imposed voltage limit.

17. The apparatus for implementing enhanced detection of circuit design limitations and stresses as recited in claim 15 wherein said simulation program displays the schematic with user selected colors for devices operating outside a set current limit.

18. The apparatus for implementing enhanced detection of circuit design limitations and stresses as recited in claim 15 wherein said simulation program displays the schematic with user selected colors for bipolar devices operating in a saturation region.

19. The apparatus for implementing enhanced detection of circuit design limitations and stresses as recited in claim 13 wherein said simulation program receives a generated simulation net list for the schematic of the circuit.

20. The apparatus for implementing enhanced detection of circuit design limitations and stresses as recited in claim 13 wherein said simulation program runs a transient simulation, an AC simulation, and a DC simulation.
